(19) United States
(12) Patent Application Publication
(10) Pub. No.: US 2010/0258651 A1
(43) Pub. Date: Oct. 14, 2010

(54) ELECTRICAL PLUG CONNECTOR AS FUEL INJECTOR CONTACT FOR SHAKEPROOF APPLICATIONS

(76) Inventors: Refik Alp Tekoral, Bamberg (DE); Peter Rehbein, Weissach (DE); Sabas Roman Tena, Lohr (DE); Michael Fleig, Gerlingen (DE)

Correspondence Address: KENYON & KENYON LLP, ONE BROADWAY, NEW YORK, NY, 10004, US

(21) Appl. No.: 12/666,390

(22) PCT Filed: Jun. 12, 2008
(86) PCT No.: PCT/EP2008/057403

§ 371 Date: Jun. 22, 2010

(30) Foreign Application Priority Data
Jun. 28, 2007 (DE) 102007029968.2

(51) Int. Cl. B05B 15/00; H01R 13/18

(52) U.S. Cl. 239/289; 439/851

(57) ABSTRACT

In an electrical plug connector in the form of a socket contact, having an inner contact part for the electrical contacting of a pin and having an external retention spring surrounding the inner contact part, the inner contact part is formed of nickel brass.

### FIELD OF THE INVENTION

The present invention relates to an electrical plug connector.

### BACKGROUND INFORMATION

A plug contact that is usual in the automotive field is described in German Patent Application No. DE 102 48 809 A1.

An electrical plug connector in the form of a vibration-stressed socket contact for producing an electrical plug connection in the motor vehicle field is described in German Patent Application No. DE 102 48 809 A1. The electrical plug connector is made up of an inner contact part and an external retention spring. The inner part itself includes contact lamellae, which rest against a mating component, preferably a knife blade, at a contact point. In order to ensure increased contact security by an optimum normal contact force for each contact lamella, even in the case of slanting or vibrating or wobbling mating components, the inner contact part has at least three guiding contact lamellae, each of the contact lamellae having at least one contact point for producing an electrical plug connection with one knife blade. In the state of a produced, electrical plug connection, the free ends 12 of the contact lamellae rest on support elements, which are designed to be a part of the external retention spring, in this case.

Additional electrical plug connectors are described in, for example, German Patent Application No. DE 202 08 635 U1, European Patent No. EP 0 971 446 A2 and German Patent Application No. DE 102 24 683 A1.

Relative micromotions, which occur based on vibrations of the components (mounting location) of the wiring harness, lead to wear between the socket contact and the knife blade. For the electrical functioning, the classical wear borderline is reached if, in the case of gold plating, the coating (surface) is worn through or if, in the case of tinning, tin oxide is created by frictional corrosion, or the tin is also worn through. Classical remedial measures against this contact wear that is caused by engine vibrations or temperature changes, i.e., frictional corrosion in the case of tinned systems or wearing through in the case of gold-plated or silver-plated systems, are decoupling elements such as a metallic meander band or a little copper band designed as a looping, which are effective, to be sure, but make the contact more expensive, and which, as a rule, weaken the current-carrying capability (because of the tapering of the cross section) or, in individual cases, even an increased contact normal force in order to improve the response to shaking, the possible variation in the normal force being usually limited by the plastic properties (yield point) of the copper material of the contact springs (lamellae).

In the case of fuel injectors, for the electrical connection of a control module to a magnetic valve, provided in a nozzle module, of a magnetic subassembly, a plug contact having a 6-finger contact (cf. German Patent Application No. DE 10 2005 017 424 A1) is provided in the control module, into which a pin of the nozzle module is inserted. The nickel-plated and gold-plated 6-finger contact is pressed into a plug socket which is provided with a shrink tube and an insulating sleeve for insulation (i.e. the avoidance of a short circuit). The electrically conductive connection is created in the fuel injector, beginning at the terminal stud in the control module, and via the 6-finger contact and a solid conductor, all the way to the magnet assembly, and back. The contact makes possible the reproducible mounting and dismounting of the control module, and makes possible the control of the magnetic group in the nozzle module for the injection. The magnetic subassembly is fixed in the nozzle module and the plug socket is fixed in the control module. Because of the connection of a booster in the fuel injector, the injector becomes lengthened microscopically (by ca. a few μm), whereby the pin is pulled out of the contact range. The pressure drops because of the injection, and the pin is pushed into the contact range again. As calculated cumulatively over the injection cycles and the lifetime, the plug contact travels a path of one kilometer. The gold surface of the conventional plug contact is worn through frictionally down to the base material and into the base material, over its lifetime. The gold surface has the task of protecting the base material from oxidation and, based on its hardness, of reducing wear. The nickel layer has the task of preventing diffusion of the less noble base material into the gold surface. If there is no gold surface present, there is an increased risk of an oxide layer forming on the base material, and the contact location (contact/solid conductor) becomes highly resistive. This may lead to the magnetic subassembly not being supplied with current any more, and no injection is possible, as a result. Based on the constructive design of the fuel injector, the relative motion between the solid conductor (pin) and the plug contact cannot be eliminated.

### SUMMARY

Because of the use, according to example embodiments of the present invention, of nickel brass, the service life (wear limit) is not limited by the layer being rubbed through (gold, tin, silver) or by frictional corrosion, particularly since no microcurrents are being applied in this instance. Nickel brass is a silvery-white shining alloy of 45-70% copper, 5-30% nickel, 8-45% zinc, possibly with the admixture of trace elements such as lead, tin or iron. Because of its nickel content, it stands out by its particular hardness and corrosion resistance.

The disadvantage of a pure nickel brass construction, due to mechanical characteristics (yield point, module of elasticity), namely, that the achievable normal force is not sufficient to compensate for a large wear erosion by relative motions/micromotions, is able to be removed by the skillful coupling with an external retention spring made of spring steel. Spring steel is poor in its relaxation properties, is high-strength, stainless, and, by its strength, it is able to cause substantially greater contact forced than Cu alloys, since the contact forces (normal forces) superpose themselves, and sufficiently great normal forces are still able to be implemented for the tolerances of manufacturing plus the depth of wear. According to theoretical calculations using FEM (finite element method), normal forces (nominal forces) in the range of 2 to 16 N are able to be set, and that is approximately one order of magnitude greater than the 1 N for the plug contact described in German Patent Application No. DE 10 2005 017 424 A1. Increased plugging forces are unimportant for plugs, because of industrial assembly instead of manual assembly. Because of the high normal forces possible according to example embodiments of the present invention, a compact contact construction having a lesser length and a lesser diameter is also possible, so that, for instance, a pin having a diameter of 1 mm is able to be contacted. In other words, large contact forces (normal contact forces) are implemented in a small space, and consequently high electrical reliability is achieved.

By the use of nickel brass as the contact material in Diesel injectors based on magnetic valves, the electrical disadvantage (relatively poor conductivity) may be ignored because, generally, only very brief currents under 10 Amp occur, timed in a range of μs (to ms), which means only small effective currents/equivalent currents of less than one Amp. That is why the disadvantageous conductivity does not lead to thermal overheating or to any thermal damage. The additional voltage drop in the range of less than mOhm (ca. 20 mOhm theoretical) is negligible in relation to the voltage drops of the overall system and/or the wiring harness, since the length of the inner part of the contact and of the external retention spring of the plug contact, according to the example embodiments of the present invention, has a size of only a few mm (ca. 4-9 mm).

The example plug connector according to the present invention enables allowing wear of <0.2 mm per contact area without the formation of an oxide layer. Since there is no layer, there is no need for the failure criterion of frictional layer wear. By raising the normal contact force per contact area by a factor of 10, it is achieved that the micromotions may be reduced, and consequently wear is reduced. In addition, the quality requirements may be satisfied, because, when using such a high normal force, the thickness of films of other materials are able to be pressed through, in order to hold the electrical transition resistance to be small and stable. The example plug connector according to the present invention may also be used under Diesel engine conditions, that is, in engine oil environments, engine oil/water environments and engine oil/Diesel fuel/water environments.

The following are additional advantages of the example plug connector according to the present invention:
a) neutral as to space, i.e., outer geometry/installation measurements are like the current construction design. In response to the change to nickel brass construction according to the present invention, the components in which the plug socket is installed/plugged through remains unchanged. A change may thus take place rapidly and without coordination with other components.
b) The functionalities are distributed to a plurality of components, namely transmitting the current through the inner contact part, applying of the normal contact force by the external retention spring (e.g. made of spring steel, CuBe₂, or the like) and position fixing by the socket, over the entire service life, which makes the construction more robust. Furthermore, each component is able to be optimized for its task.
c) The contact system requires no surface protection made of, for instance, gold or silver. Because of the use of nickel brass, the service life (wear limit) is not limited by frictional layer wear (gold, tin, silver) or by frictional corrosion.
d) contact forces (normal contact force) per contact location are higher by a factor of 10 compared to plug connectors known up to now. As a result, no current interruptions take place that are caused by too little contact forces, and wear is reduced by the elimination of micromotions.
e) considerable potential for cost savings, since the pin contacted in the plug contact no longer has to be partially gilded and tinned.
f) the use in an engine oil environment and non-sealed constructions is possible, in which the contact area is wetted by media such as engine oil, etc., at temperatures of −40° C. to 140° C.

### BRIEF DESCRIPTION OF THE DRAWINGS

An example electrical plug connector according to the present invention is shown in the figures and is explained in detail below. The features shown in the figures are purely schematic, and are not to be regarded as being to scale.

FIG. 1 shows an exemplary embodiment of the electrical plug connector according to the present invention.

FIG. 2 shows a fuel injector having a nozzle module and a control module which has the plug connector shown in FIG. 1.

### DETAILED DESCRIPTION OF EXAMPLE EMBODIMENTS

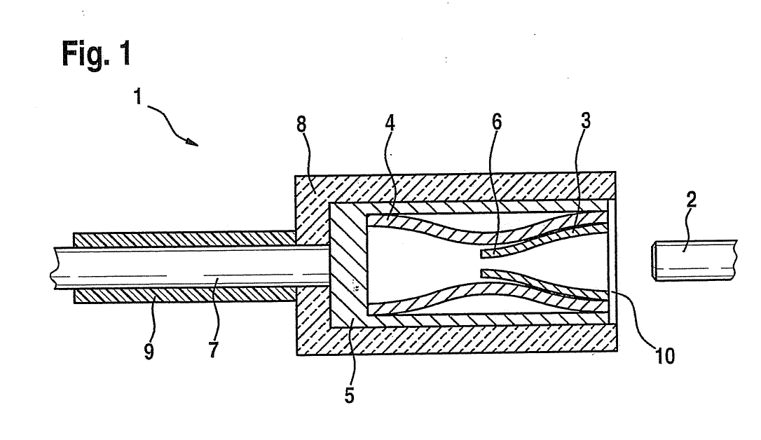

Electrical plug 1 shown in FIG. 1 is designed as a socket contact or round contact, and is used for the electrical contacting of a pin 2.

Electrical plug 1 includes an inner contact part 3 for electrically contacting pin 2, an external retention spring 4 that surrounds inner contact part 3, and a metal socket 5. Inner contact part 3 is made of nickel brass, preferably N18 (Wieland trade name), and in the exemplary embodiment shown is developed as a longitudinally slitted round sleeve, which has a plurality of contact fingers (lamellae) 6 that are directed inwards and may be formed by a rolled-up sheet metal part made of nickel brass. Thus, inner contact part 3 has no surface coating, particularly no gold, silver or tin coating. Inner contact part 3 is set tightly in external retention spring 4, which is formed of stainless spring steel (e.g., 1.4310 having a strength of 1500 MPA). External retention spring 4, in turn, is mounted in metal socket 5, made, for instance, of brass, and is jammed into it, the jamming force being greater than the plugging force of pin 2. Metal socket 5 is connected electrically conductively to inner contact part 3 via external retention spring 4, and on its part is fastened on the stripped end of an electric line 7.

Metal socket 5 is surrounded by an insulating sleeve 8, and electric line 7 is covered by a shrink tube 9.

The contact force and the stiffness of inner contact part 3 are able to be adjusted by the thickness of the sheet metal or the wall, the length of contact fingers 6 and the width of the longitudinal slits. The normal force of contact fingers 6 may be massively increased by the superposing of the external retention spring 4 and trimmed to the target range, in order to adjust both manufacturing tolerances and the removal by wear. To develop the electrical plug connection, pin 2, for example a round pin made of nickel brass having a 1 mm diameter, is plugged into opening 10 of metal socket 5 and between contact fingers 6 of inner contact part 3, and, in fact, against the restoring action of external retention spring 4.

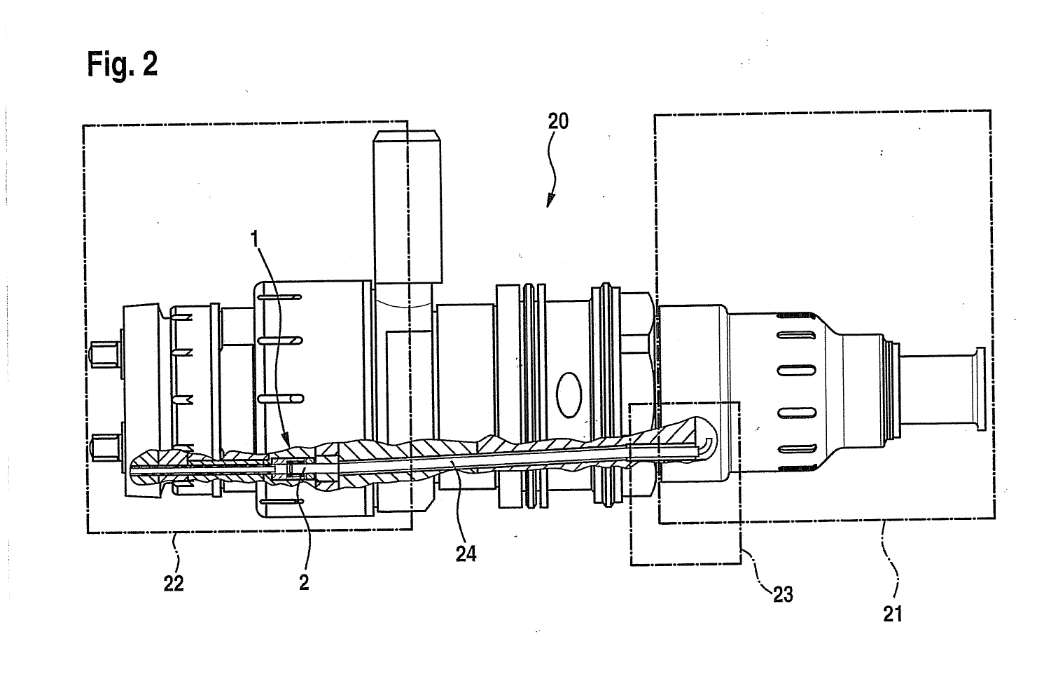

FIG. 2 shows a fuel injector 20 having a nozzle module 21 and a control module 22 which has the plug connector shown in FIG. 1. The fuel injection is controlled with the aid of a magnetic valve (not shown), which is a part of a magnet assembly 23 of nozzle module 21. Magnet assembly 23 has a solid conductor 24, that extends that extends to control module 22, and that is preferably also made of nickel brass, whose end, developed as pin 2, is plugged into plug connector 1 in control module 22. Plug connector 1 makes possible a wear of <0.2 mm per contact area without the formation of an oxide layer. Since there is no oxide layer, there is no need for the failure criterion of frictional layer wear. Because of the increase in the normal contact force, per contact area, by a factor of 10, micromotions between solid conductor 24 and inner contact part 3 are reduced, and consequently so is wear. In addition, because of the great normal force, the electrical transition resistance between solid conductor 24 and inner contact part 3 is held to small and stable, whereby, at temperatures up to ca. 140° C. and over a service life of 24,000 h, neither current interruptions nor high resistance occur in control module 22.

1-10. (canceled)

11. An electrical plug connector in the form of a socket contact, comprising:
an inner contact part for an electrical contacting of a pin; and
an external retention spring surrounding the inner contact part;
wherein the inner contact part is made of nickel brass.

12. The electrical plug connector as recited in claim 11, wherein the inner contact part is without a surface coating.

13. The electrical plug connector as recited in claim 11, wherein the inner contact part is held inside the external retention spring in a jammed manner and is connected to the external retention spring in an electrically conductive manner.

14. The electrical plug connector as recited in claim 11, wherein the external retention spring is situated within a metal socket in a jammed manner, and the metal socket is connected to the inner contact part in an electrically conductive manner.

15. The electrical plug connector as recited in claim 14, wherein the inner contact part and the metal socket are connected to each other in an electrically conductive manner via the external retention spring that is situated between them.

16. The electrical plug connector as recited in claim 14, wherein the metal socket is a sleeve.

17. The electrical plug connector as recited in claim 11, wherein the inner contact part is a sleeve.

18. The electrical plug connector as recited in claim 17, wherein the sleeve is slitted and has a plurality of contact fingers.

19. The electrical plug connector as recited in claim 17, wherein the sleeve is a rolled-up sheet metal part.

20. A fuel injector, comprising:
at least two modules; and
an electrical plug connector in the form of a socket contact, including an inner contact port for an electrical contacting of a pin, and an external retention spring surrounding the inner contact port, the inner contact port being made of nickel brass;
wherein the plug connector is provided in one of the two modules, and the other module includes the pin, the pin being plugged into the electrical plug connection.
